(19) United States
(12) Patent Application Publication
(10) Pub. No.: US 2014/0215613 A1
(43) Pub. Date: Jul. 31, 2014

(54) ATTACK RESISTANT COMPUTER SYSTEM

(71) Applicant: INTERNATIONAL BUSINESS MACHINES CORPORATION, Armonk, NY (US)

(72) Inventors: John F. Kelley, Clarkesville, GA (US); Todd Seager, Orem, UT (US)

(73) Assignee: INTERNATIONAL BUSINESS MACHINES CORPORATION, Armonk, NY (US)

(21) Appl. No.: 13/750,025

(22) Filed: Jan. 25, 2013

(51) Int. Cl. G06F 21/55

(52) U.S. Cl. CPC G06F 21/55
USPC 726/23

(57) ABSTRACT

A computer system where a second, dedicated processor (sometimes called an SPU, to distinguish from the central processing unit (CPU)) has logic to manage and control an intrusion detection hardware set and an intrusion response hardware set. The intrusion response hardware detects physical intrusions (for example, cryogenic attacks), and the response hardware set responds in various ways to attempt to protect the sensitive data in a volatile memory from the detected physical intrusion. A dedicated power storage device powers the SPU and the intrusion response hardware set.

### FIELD OF THE INVENTION

The present invention relates generally to the field of computers that include volatile memory (such as a volatile random-access memory), and more particularly to computers that store sensitive information (such as encryption keys or decrypted information that is normally subject to encryption) in a volatile memory.

### BACKGROUND OF THE INVENTION

Storing data in volatile memory devices is known. As used herein, the term “volatile memory” is any data storage memory that requires a substantially continuous supply of energy, under normal operating conditions, in order to reliably maintain the data stored in the volatile memory. It is understood that many volatile memories operate on an energy supply that is intermittent, but, even in these cases, the intervals are frequent such that the energy supply should be understood to be understood to be “substantially continuous” for purposes of this document.

Random-access memory (RAM) is known. As used herein, the term RAM will refer to all random-access memory devices, now known or to be developed in the future, such as the following types: dynamic random-access memory (DRAM) and static random-access memory (SRAM). With random-access devices, any storage location, within the memory addresses, is accessed essentially in the same amount of time and in any arbitrary order. “Volatile” and “random-access” are not synonymous terms, but many volatile memories are random-access and most random-access memories are volatile.

A basic assumption of volatile memory is that when volatile memory loses its substantially continuous energy supply (typically electrical power), the data stored in the volatile memory will be quickly lost. This assumption has been proven incorrect, at least for some volatile memories, when the volatile memory is cooled to a relatively low temperature that is sufficiently low to cause a volatile memory to maintain its data for a substantial amount of time even after the energy source of the volatile memory has been cut off or otherwise removed. Herein, the term “cryogenic temperature” will be used to refer to a temperature sufficiently low to cause a volatile memory to maintain its stored data.

Cryptography is a known technique that is commonly used today to protect against unauthorized data access. In many conventional cryptography schemes, encryption keys are used. An encryption key allows an entity who has the encryption key to read encrypted data. Encryption keys are often stored in volatile, random-access memory. It is assumed that if the computer that stores the encryption key is stolen, then the computer will lose its power and the encryption key will be erased before an unauthorized party can make use of the encryption key (and/or other sensitive data) stored in the volatile memory.

### SUMMARY

According to one aspect of the present invention, a computer system includes: a first processor set; a second processor set; a volatile memory hardware set; an intrusion detection hardware set; and an intrusion response hardware set. The first processor set is structured, located, programmed and/or connected to run an operating system for controlling basic operations of the computer system. The volatile memory hardware set is structured, located, connected and/or programmed to store data for use by the first processor set. The intrusion detection hardware set is structured, located, connected and/or programmed to send out a set of first signal(s) including at least one signal. The second processor set is structured, connected, located and/or programmed to: (i) receive the set of first signal(s), (ii) to process the set of first signal(s) to determine whether a physical access condition exists, and (iii) responsive to a determination that a physical access condition exists, send out a set of response signal(s) including at least one signal. The intrusion response hardware set is structured, located, connected and/or programmed to: (i) receive the set of response signal(s), and (ii) responsive to the set of response signal(s), make at least one responsive action to protect the volatile memory hardware set from any unauthorized access related to the determined physical access condition.

According to a further aspect of the present invention, a memory board assembly is for use in a computer having an intrusion detection hardware set and an intrusion response hardware set. The assembly includes: a processing hardware set; a set of VM chip(s) including at least one VM chip; a substrate; and a power storage device. The substrate is a VM board. The processing hardware set, the set of VM chip(s) and power storage device are mounted on the substrate. The processing hardware set is structured, located, connected and/or programmed to: (i) receive a first signal from the intrusion detection hardware set, (ii) determine whether a physical access condition exists based on the received first signal, and (iii) control an intrusion response to help prevent unauthorized access to data stored in the set of VM chip(s) related to the determined physical access signal. The power storage device and the processing hardware set are operatively connected so that the power storage device will continue to power operations of the processing hardware set even when power to the computer is interrupted.

### BRIEF DESCRIPTION OF THE SEVERAL VIEWS OF THE DRAWINGS

FIG. 1 is a schematic view of a first embodiment of a computer system according to the present invention;

FIG. 2 is a schematic view of a portion of the first embodiment computer system;

FIG. 3 is a flowchart showing a process according to the present invention; and

FIG. 4 is a schematic view of a portion of the first embodiment computer system.

### DETAILED DESCRIPTION

As will be appreciated by one skilled in the art, aspects of the present invention may be embodied as a system, method or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present invention may take the form of a computer program product embodied in one or more computer-readable medium(s) having computer readable program code/instructions embodied thereon.

Any combination of computer-readable media may be utilized. Computer-readable media may be a computer-readable signal medium or a computer-readable storage medium. A computer-readable storage medium may be, for example, but not limited to, an electronic, magnetic, optical, electromagnetic, infrared, or semiconductor system, apparatus, or device, or any suitable combination of the foregoing. More specific examples (a non-exhaustive list) of a computer-readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer-readable storage medium may be any tangible medium that can contain, or store a program for use by or in connection with an instruction execution system, apparatus, or device.

A computer-readable signal medium may include a propagated data signal with computer-readable program code embodied therein, for example, in baseband or as part of a carrier wave. Such a propagated signal may take any of a variety of forms, including, but not limited to, electro-magnetic, optical, or any suitable combination thereof. A computer-readable signal medium may be any computer-readable medium that is not a computer-readable storage medium and that can communicate, propagate, or transport a program for use by or in connection with an instruction execution system, apparatus, or device.

Program code embodied on a computer-readable medium may be transmitted using any appropriate medium, including but not limited to wireless, wireline, optical fiber cable, RF, etc., or any suitable combination of the foregoing.

Computer program code for carrying out operations for aspects of the present invention may be written in any combination of one or more programming languages, including an object oriented programming language such as Java (note: the term(s) “Java” may be subject to trademark rights in various jurisdictions throughout the world and are used here only in reference to the products or services properly denominated by the marks to the extent that such trademark rights may exist), Smalltalk, C++ or the like and conventional procedural programming languages, such as the “C” programming language or similar programming languages. The program code may execute entirely on a user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present invention are described below with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer-readable medium that can direct a computer, other programmable data processing apparatus, or other devices to function in a particular manner, such that the instructions stored in the computer-readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer-implemented process such that the instructions which execute on the computer or other programmable apparatus provide processes for implementing the functions/acts specified in the flowchart and/or block diagram block or blocks.

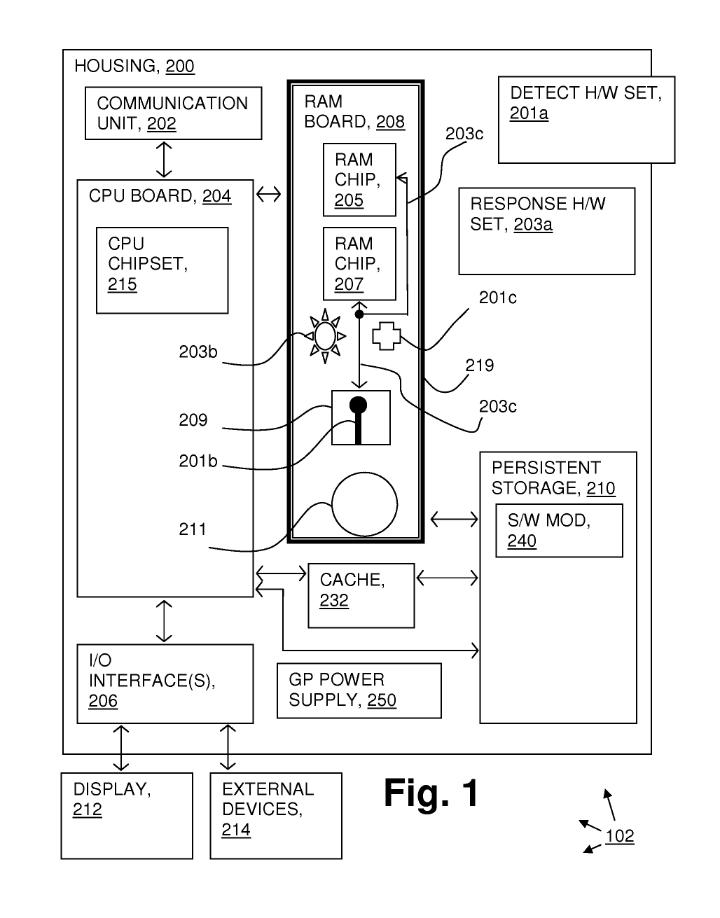

The present invention will now be described in detail with reference to the Figures. FIGS. 1, 2 and 4 collectively make up a block diagram illustrating various portions of general-purpose computer system 102, including: computer housing 200; communication(s) unit 202; central processing unit (CPU) board 204; I/O (input/output) interface module(s) 206; random access memory (RAM) board assembly 208; cache memory 232; general purpose (GP) power supply 250; housing-mounted portion of detection hardware (h/w) set 201a; off-RAM-board portion of response hardware set 203a; persistent storage device 210; display device 212; external devices 214; sub-assembly 450; and communication lines 452, 454, 456, 462, 469, 470. CPU board 204 includes CPU chipset (or, simply, CPU) 215. Persistent storage device 210 has stored therein software (s/w) module (mod) 240. RAM board assembly 208 includes: RAM chips 205, 207; optical microswitch portion of detection hardware set 201b; thermal sensor portion of detection hardware set 201c; RAM-heating portion of response hardware set 203b; communication line portion of response hardware set 203c; security processor unit (SPU) 209; battery 211; and thermal insulation layer 219.

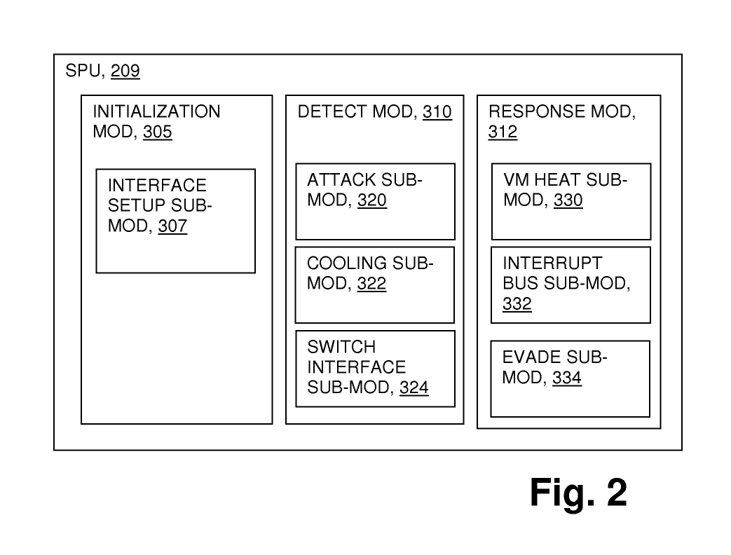

As shown in FIG. 2, SPU 209 includes: initialization mod 305 (including interface setup sub-mod 307); detect mod 310; and response mod 312. Detect mod 310 includes: attack sub-mod 320; cooling sub-mod 322; and switch interface sub-mod 324. Response mod 312 includes: volatile memory (VM) heat sub-mod 330; interrupt bus sub-mod 332; and evade sub-mod 334.

As best shown in FIG. 1, computer system 102 may take many different forms, such as a laptop computer, tablet computer, netbook computer, personal computer (PC), a desktop computer, a personal digital assistant (PDA), a smart phone, or any programmable electronic device. As further shown in FIG. 1, software mod 240 is a collection of machine readable instructions and data that is used to create, manage and control certain normal operations of computer system 102. For example, software mod 240 may include conventional operating system software and conventional word processing software.

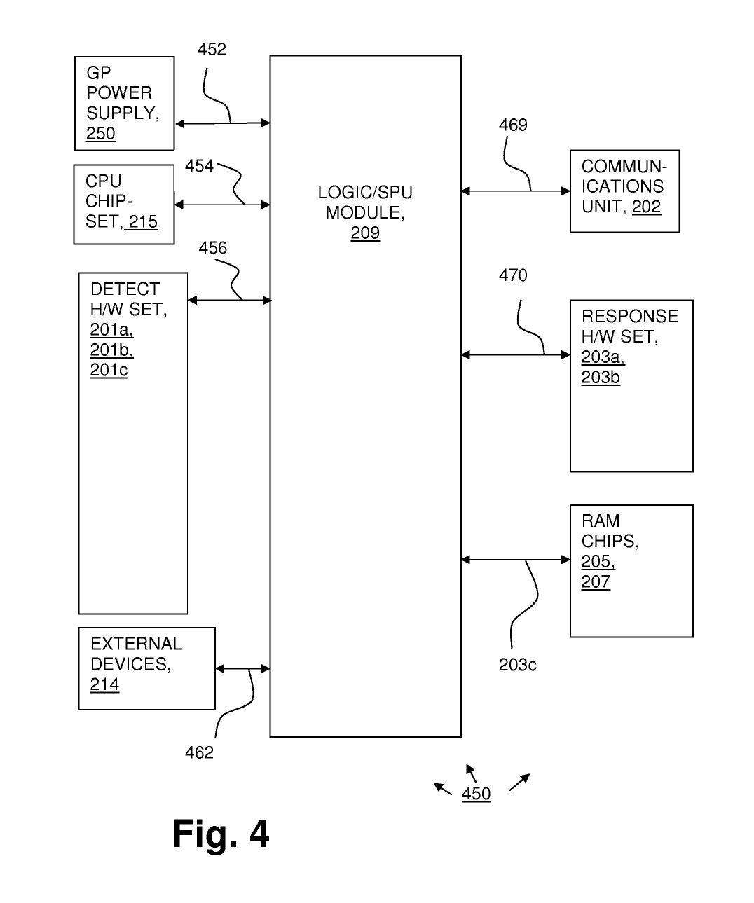

As shown in FIG. 1, computer system 102 is shown as a block diagram with many double arrows. These double arrows (no separate reference numerals) represent a communications fabric, which provides communications between various components of sub-system 102. This communications fabric can be implemented with any architecture designed for passing data and/or control information between processors (such as microprocessors, communications and network processors, etc.), system memory, peripheral devices, and any other hardware components within a system. For example, the communications fabric can be implemented, at least in part, with one or more buses. As shown in FIG. 4, communication lines 452, 454, 456, 462, 469, 470, are a portion of this fabric which will be discussed in more detail below.

RAM chips (or, simply, RAM) 205, 207 provide a memory for system 102 that is both volatile and random accessible. The protection of sensitive data stored in RAM 205, 207 will be discussed in detail below.

Persistent storage 210 is at least more persistent than a signal in transit is, but the persistent storage may, of course, be substantially less persistent than permanent storage. Mod 240 may include both machine readable and performable instructions and/or substantive data (that is, the type of data stored in a database). In this particular embodiment, persistent storage 210 includes a magnetic hard disk drive. To name some possible variations, persistent storage 210 may include a solid state hard drive, a semiconductor storage device, read-only memory (ROM), erasable programmable read-only memory (EPROM), flash memory, or any other computer-readable storage media that is capable of storing program instructions or digital information.

The media used by persistent storage 210 may also be removable. For example, a removable hard drive may be used for persistent storage 210. Other examples include optical and magnetic disks, thumb drives, and smart cards that are inserted into a drive for transfer onto another computer-readable storage medium that is also part of persistent storage 210.

Communications unit 202, in these examples, provides for communications with other data processing systems or devices external to sub-system 102. In these examples, communications unit 202 includes one or more network interface cards. Communications unit 202 may provide communications through the use of either or both physical and wireless communications links. Any software modules discussed herein may be downloaded to a persistent storage device (such as persistent storage device 210) through a communications unit (such as communications unit 202).

I/O interface(s) 206 allows for input and output of data with other devices that may be connected locally in data communication with a conventional server and/or a conventional client. For example, I/O interface 206 provides a connection to external device set 214. External device set 214 will typically include devices such as a keyboard, keypad, a touch screen, and/or some other suitable input device. External device set 214 can also include portable computer-readable storage media such as, for example, thumb drives, portable optical or magnetic disks, and memory cards. Software and data used to practice embodiments of the present invention, for example, software module 240, can be stored on such portable computer-readable storage media. In these embodiments the relevant software may (or may not) be loaded, in whole or in part, onto persistent storage device 210 via I/O interface set 206. I/O interface set 206 also connects in data communication with display device 212.

Display device 212 provides a mechanism to display data to a user and may be, for example, a computer monitor or a smart phone display screen.

GP power supply 250 is a conventional power supply. This power supply may include multiple components (not separately shown in FIG. 1). GP power supply 250: (i) receives utility power, in alternating current (AC) form; (ii) converts the AC electrical power to direct current (DC) electrical power; and (iii) supplies DC electrical power, at various predetermined DC voltages, to the various active components of system 102. If the power from the GP power supply is interrupted for any substantial amount of time then the computer, including CPU 215, will terminate normal operations for lack of power. A conventional computer, who's CPU is powered exclusively by a utility powered power supply like GP power supply 250, will herein be referred to as a “utility-powered computer.”

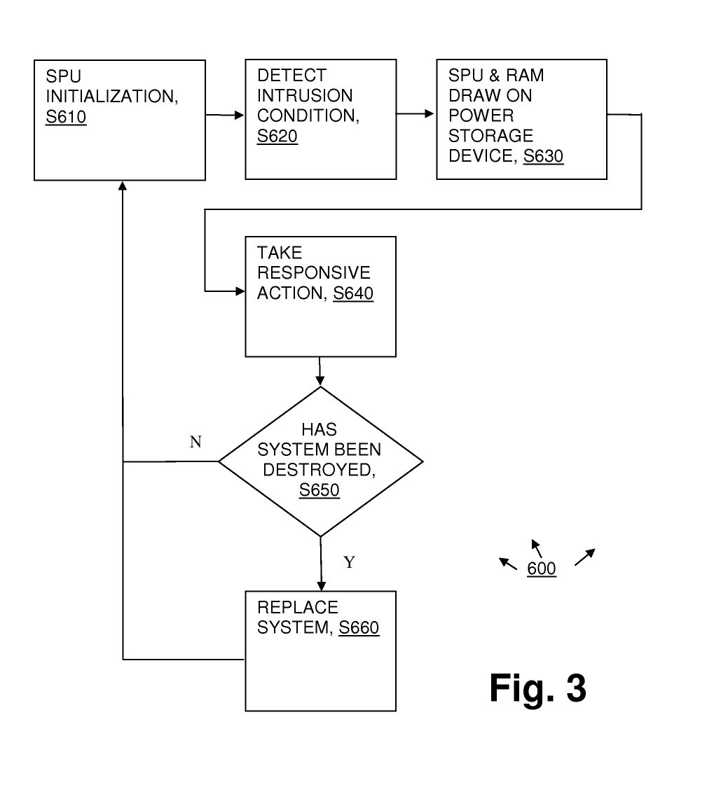

Turning now to FIG. 3, the process step blocks of FIG. 3 now will be discussed in the following paragraphs. Generally speaking, FIG. 3 describes a cryogenic attack on RAM 205, 207 of computer system 102, and the response to the attack made by system 102. However, it should be kept in mind that that process 600 is just one example of an attack-and-response according to the present invention. For example, the attack may be an attack other than a cryogenic attack. Other embodiments of the present invention are, alternatively or additionally, concerned with attacks or conditions involving other types of physical access (see Definition of “physical access” below). In some embodiments, the protected memory may not be a volatile memory.

At step s610 in process 600 initialization mod 305 (see FIG. 2) initializes SPU 209. This initialization step causes SPU 209 to begin its normal operations of detecting potential attempted unauthorized access and responding to potential attempted unauthorized access. In this example, the initialization of step s610 includes the following: (i) calibration of sensors; (ii) built-in-tests (BITs); (iii) checksum verifications; and (iv) initialization of interfaces. With respect to item (iv), interface setup sub-mod 307 (see FIG. 2) performs all the initialization necessary for SPU 209 to interface with the detection-related and response-related devices for which SPU 209 provides logic and/or processing.

In this example, item (iv) interface initialization includes: (a) initialization of detection-related parameters, such as the temperature threshold value (see FIG. 4 at detection hardware set 201a, b, c and communication line 456); (b) initialization of response-related parameters (see FIG. 4 at response hardware set 203a, b, c and communication line 470); (c) setup handshaking and/or protocols for external communications (see FIG. 4 at communications unit 202 and communication line 469); and (d) reading/writing/responding to CPU chipset messages (see FIG. 4 at CPU chipset 215 and communication line 454). With respect to item (d), it should be noted that whether and how SPU 209 responds to commands from CPU 215 is a potentially sensitive area that should preferably be handled carefully by the system designer. On one hand, if SPU 209 always responds to commands from CPU 215 then an unauthorized party with effective control of CPU 215 may shut down, or otherwise compromise, SPU 209, and thereby prevent SPU 209 from responding to an attempt to make unauthorized access of sensitive data in the volatile memory. On the other hand, it may be desired for CPU 215, and legitimate parties in legitimate control of CPU 215 to communicate with SPU 209 in various ways (for example, to set a cryogenic threshold temperature, to determine that SPU 209 is operating normally, etc.). In view of these conflicting design imperatives, the system designer should decide carefully whether, and/or under what conditions, to allow SPU 209 to receive communications and/or respond to instructions from CPU 215.

SPU 209 deals exclusively with volatile memory security, and its initialization does not rely on CPU 215 and its initialization is preferably not controlled, to any substantial degree, by CPU 215. Furthermore, SPU 209 is firewalled, or otherwise prevented, from taking commands from external sources that could potentially compromise its central task of protecting the data in volatile memory. It is noted that some SPU initialization-type functions may occur intermittently during normal operations. For example, thermal sensor(s) may be calibrated and/or tested periodically.

As shown in FIG. 3, processing proceeds from step s610 to step s620, where detect hardware set 201a, b, c and SPU 209 (see FIGS. 1 and 4) work co-operatively in order to detect potential intrusion condition(s). More specifically, detect mod 310 (see FIG. 2) of SPU 209 includes software programmed to receive data from detect hardware set 201a, b, c in order to determine whether a potential attack is occurring. Even more specifically, indications of a potential attack are detected as follows: (i) attack sub-mod 320 receives data from housing-mounted portion of detection hardware set 201a to determine whether housing 200 is being opened in an unauthorized manner; (ii) cooling sub-mod 322 receives data from thermal sensor portion of detection hardware set 201c to determine whether it is being attempted to cool the volatile memory (that is, RAM 205, 207) down to a cryogenic temperature for a cryogenic attack; and (iii) switch interface sub-mod 324 receives data from optical microswitch portion of detection hardware set 201b in order to determine whether RAM board assembly 208 is being moved, or removed, relative to the other hardware in system 102.

With the thermal sensor portion of the detection hardware set 201c, the system designer should carefully consider whether this sensor is best placed: (i) inside thermal insulation layer 219 (see FIG. 1); (ii) on RAM board assembly 208, but outside of thermal insulation layer 219; and/or (iii) elsewhere in or on housing 200 (see FIG. 1). The thermal sensor, or sensors, should be placed at location(s) where they are most likely to quickly, and reliably, detect a potential cryogenic attack.

Similarly, the optical microswitch should probably at least extend outside of the thermal insulation layer, and should be located, and oriented, to most reliably detect that an attempt is being made to remove RAM board assembly 208 from system 102. The optical microswitch may be powered by battery 211 (see FIG. 1), or by GP power supply 250. In this example, tripping of the switch is not considered as a potential attack unless GP power supply is operating to supply power to the system as a whole. This way, RAM board 208 may be removed without any sort of defensive response by SPU 209, so long as the system is powered down.

In other embodiments, the detection hardware set may be designed and constructed to detect different, or additional, types of indications of potential attacks. Other potential indications of potential unauthorized physical access attempts may: (i) cycling the power, as soft or hard boots; (ii) use of electromagnetic devices to read the data stored in volatile memory; (iii) use of targeted electric charges to defeat the invention's onboard security features before freezing; (iv) covert channel analysis; and/or (v) physical surveillance of RAM operation.

Focusing on housing-mounted portion of detection hardware set 201a and its associated SPU logic in attack sub-mod 320 (see FIGS. 1 and 2), the attack sub-mod detects intrusion from signals generated by the housing sensors and sends these signals to sub-mod 320 over communication line 456 (see FIG. 4). The housing sensors of hardware set 201 are placed at key locations to detect tampering. These locations typically include screw holes, locks and communication ports for peripheral devices. These housing-mounted sensors may be, include, or exhibit one or more of the following characteristics: (i) microswitch tamper sensors; (ii) mechanical triggers (such as a spring or button); (iii) electrical switch; (iv) sonic detector; (v) optical detector; or (vi) located on a surface of the housing; (vii) mounted within the interior space of the housing; and/or (viii) partially, or completely, embedded in the material of the housing. Sub-mod 320 processes signals from housing-mounted hardware set portion 201a to determine when the signal(s) indicate a potential attack that compromises the integrity of the housing.

Focusing now on thermal sensor portion of detection hardware set 201c and its associated SPU logic in cooling sub-mod 322 (see FIGS. 1 and 2), another form of an attack is to cool the volatile memory, down to a “cryogenic temperature,” in an attempt to prolong a remanence property of the memory. The anticipated means to cool the volatile memory in a cryogenic attack may affect what kind of thermal sensors are used and/or where they are located within system 102. Depending upon the way an attacker attempts to chill RAM chips 205, 207, the following cooling patterns might be expected: (i) only cooling the RAM chips 205, 207; (ii) cooling entire RAM board assembly 208; or (iii) cooling entire computer system 102 (or at least the entire portion within housing 200). These different possible cooling patterns may affect optimal thermal sensor placement. Methods to process thermal sensor data signals include: (i) taking the average of the sensors; (ii) taking a weighted average based upon time; and/or (iii) exponential-moving-average.

Cooling sub-mod 322 compares a calculated and/or received temperature and compares it to a threshold value. A temperature below the threshold is taken as indicative of a potential cryogenic attack. This threshold temperature can be: (i) permanently set at manufacturing; (ii) set via a Basic Input/Output System (BIOS, not separately shown in the Figures) during pre-boot; (iii) set during normal operation of computer system 102 through its operating system (OS, not separately shown); (iv) set by hardware and/or software external to computer system 102; (v) set by dedicated hardware (not shown) that is built into the computer and communicates directly with the SPU; and/or (vi) by any combination of the foregoing methods.

As mentioned above, another form of an attack is to cycle power, as in a cold-boot. Cold-booting refers to: (i) cycling power from “on-off-on” without letting a computer shut down cleanly; (ii) pressing the “reset” button quickly and repeatedly; or (iii) similar tactics designed to subvert the normal shutting down and booting up processes. A light-weight operating system is then immediately booted (for example, from a USB flash drive), and the contents of pre-boot memory dumped to a file. Accordingly, embodiments of the present invention may include logic in the SPU to receive signals related to booting patterns, and use this information to determine whether a potential cold boot attack is occurring.

Returning to FIG. 3, step S620 ends when the SPU has determined that a potential unauthorized condition has developed. When this happens, processing proceeds from step s620 to step s630 where SPU 209 (see FIG. 1) begins to (or continues to) draw its power from battery 211. More specifically, even if the SPU is powered by GP power supply 250 during step s620, once a potential attack is detected it becomes likely that this GP power supply will be cut off at any time. The presence of a self-contained storage device on RAM board assembly 208 enables the SPU to be a stand-alone processing module, and, therefore, continue to operate even in the absence of system power. In embodiment 102, the SPU-dedicated power storage device is a re-chargeable battery, but it may take the form of other energy storage devices now known or to be developed in the future. This continuing source of power allows SPU to take responsive actions to the detected potential unauthorized access, as will be discussed in detail below.

As shown in FIG. 3, processing proceeds from step s630 to step s640, where SPU 209 controls and causes response action to be taken in response to the potential unauthorized access condition that has been determined at step s620. More specifically, response mod 312 (see FIG. 2) of SPU 209 sends out appropriate signals to effect one or more of the following responses to the potential unauthorized access condition: (i) VM heat sub-mod 330 (see FIG. 2) causes RAM-heating portion of response hardware set 203b (see FIGS. 1 and 4) to heat RAM board assembly 208 (including RAM chips 205, 207) in order to counter an attempted cryogenic cooling so that any sensitive data stored in the RAM chips is lost; (ii) interrupt bus sub-mod 332 (see FIG. 2) causes off-RAM-board portion of response hardware set 203a (see FIGS. 1 and 4) to take responsive action(s) as described below; and (iii) evade sub-mod 334 (see FIG. 2) sends out appropriate signals over communication-line portion of response hardware set 203c (see FIGS. 1 and 4) that causes data stored in the RAM chips 205, 207 to be erased and/or rewritten.

With respect to the overwriting memory caused by evade sub-mod 334, this may be done with a pattern, randomly, and/or by setting or resetting storage. The power required to effect this data overwriting is preferably supplied by battery 211 (see FIG. 1), especially because power from GP power supply 250 is likely to be interrupted during an unauthorized access attack, such as a cryogenic attack.

Evade sub-mod 334 overwrites volatile memory in an attempt to scramble memory, such that it is clearly altered in aggregate from the values and/or patterns before the attack was detected. Methods to scramble memory, or wipe the memory, include (but are not necessarily limited to): (i) overwriting volatile memory with a pattern, such as repeating the pattern of writing “0” at one address and “1” at the immediately following address; (ii) overwriting with all “0s”; (iii) overwriting with all “1”s; and (iv) any combination of “0”s and “1”s. This overwriting of the volatile memory may be repeated as many times as necessary to sanitize RAM chips 205, 207. In some embodiments, evade sub-mod 334 causes the RAM chips to be de-energized after they are re-written. In other embodiments, it may be preferable to allow the party making the unauthorized access to collect the “scrambled” data in RAM chips 205, 207 in order to trick that unauthorized party into believing that he has captured sensitive data—this may help in catching the unauthorized party later on when it attempts to use its ill-gotten (but scrambled) data.

As mentioned above, the interrupt bus sub-mod 332 causes off-RAM-board portion of response hardware set 203a to take responsive action(s) which will now be discussed. One such responsive action is to interrupt bus(es) of computer system 102 so that the interruption prevents access to volatile memory from conventional devices that utilize such memory during normal operation. This interruption may present some challenges, such as proper handshaking among all devices that use the bus(es). Still, where feasible, interruption of the bus(es) is generally desirable, as it will alleviate contention among the components of computer system 102 that normally access RAM chips 205, 207. The off-board-RAM portion of response hardware set may be structured, connected and/or programmed to take other, additional or alternative, responsive actions, such as the following: (i) physical destruction of RAM chips 205, 207; (ii) physical destruction of entire computer system 102; (iii) sounding an alarm (local or remote); (iv) sending out a notification (for example, an email notification) of the occurrence of a potential unauthorized access condition; and/or (v) mechanical or pyrotechnic interruption of the bus connection.

As shown in FIG. 3, after the responsive action ends processing proceeds to step s650, where it is determined whether computer system102 been destroyed (either by a party attempting to make unauthorized access, or by the responsive action of step s640). If computer system 102 is determined not to be salvageable, then processing proceeds to step s660, where computer system 102 is replaced.

If it is determined at step s650 that computer system 102 has not been destroyed then processing proceeds to step S610.

Now that process 600 has been fully discussed, some additional comments regarding the present invention will now be made. RAM board assembly 208 is enclosed, and preferably sealed, using insulation material that is acceptable for use in a conventional computer system. This insulation provides passive resistance to a cryogenic attack. The insulation does not require any signals or control by SPU 209, CPU 215, or any other logic device. This thermal insulation may be inventive, independent of the SPU-related aspects of the present invention discussed in detail above. During normal operations, the insulation is designed and/or structured to allow RAM chips 205, 207 to operate without overheating, but will impede cooling of RAM chips 205, 207 in the event of a cryogenic attack.

The flowchart and block diagrams in the foregoing Figures illustrate the architecture, functionality, and operation of possible implementations of systems, methods and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

In some embodiments of the present invention, the RAM board assembly and/or the RAM chips are dislodged when an unauthorized access condition is detected.

In some embodiments of the present invention, there are external sensors that indicate that an attack is possible.

Although not specifically shown in the Figures, RAM board 208 includes connection hardware that makes the RAM board pluggable into a mother board in the style of a conventional subscriber identity module (SIM) card and certain other types of secondary memory boards. This can be helpful because it allows a system designer to take advantage of the enhanced security (for example SPU and/or power storage device) of the present invention without redesigning the mother board.

The following paragraphs provide definitions for certain term(s) used in this document:

Present invention: should not be taken as an absolute indication that the subject matter described by the term “present invention” is covered by either the claims as they are filed, or by the claims that may eventually issue after patent prosecution; while the term “present invention” is used to help the reader to get a general feel for which disclosures herein that are believed as maybe being new, this understanding, as indicated by use of the term “present invention,” is tentative and provisional and subject to change over the course of patent prosecution as relevant information is developed and as the claims are potentially amended.

Embodiment: see definition of “present invention” above—similar cautions apply to the term “embodiment.”

And/or: non-exclusive or; for example, A and/or B means that: (i) A is true and B is false; or (ii) A is false and B is true; or (iii) A and B are both true.

Physical access: includes, but is not limited to: (i) physically moving computer components (especially a volatile memory and/or VM board), (ii) heating or cooling computer components (such as cryogenic cooling of a VM chip and/or VM board), and/or (iii) irradiating computer components for imaging purposes (for example, taking an x-ray image of a VM chip); physical access does not include: malware attacks, virus attacks, software-based attacks and/or the like.

Physical access condition: a condition that is indicative or suggestive of unauthorized physical access being made to a computer system.

VM board: any generally flat substrate, having at least one major surface suitable for mounting electronic components that provide volatile memory data storage, and being structured to electrically interconnect into a computer assembly.

VM chips: Any relatively flat and small electronic component that: (i) provides volatile memory type data storage, and (ii) is suitable for mounting on a board; the VM chip may or may not be electronically interconnected through the board (for example, though traces and vias built into the board).

1. A computer system comprising:
a first processor set;
a second processor set;
a volatile memory hardware set;
an intrusion detection hardware set; and
an intrusion response hardware set;
wherein:
the first processor set is structured, located, programmed and/or connected to run an operating system for controlling basic operations of the computer system;
the volatile memory hardware set is structured, located, connected and/or programmed to store data for use by the first processor set;
the intrusion detection hardware set is structured, located, connected and/or programmed to send out a set of first signal(s) including at least one signal;
the second processor set is structured, connected, located and/or programmed to: (i) receive the set of first signal(s), (ii) to process the set of first signal(s) to determine whether a physical access condition exists, and (iii) responsive to a determination that a physical access condition exists, send out a set of response signal(s) including at least one signal; and
the intrusion response hardware set is structured, located, connected and/or programmed to: (i) receive the set of response signal(s), and (ii) responsive to the set of response signal(s), make at least one responsive action to protect the volatile memory hardware set from any unauthorized access related to the determined physical access condition.

2. The system of claim 1 further comprising:
a first power storage device;
wherein:
the second processor set is structured, located, programmed and/or connected so that it can be powered by the first power storage device.

3. The system of claim 2 further comprising:
a first power supply;
wherein:
the first processor set is structured, located, connected and/or programmed so that: (i) the first processor set can only be powered by the first power supply, and (ii) the first processor set is not powered by the first power storage device.

4. The system of claim 3 wherein the first power supply is structured, located, connected and/or programmed to: (i) receive alternating current form electrical power, and (ii) supply direct current form electrical power.

5. The system of claim 1 further comprising:
a first substrate;
wherein:
the second processor set and the volatile memory hardware set are mounted on the first substrate; and
the first processor set is not mounted on the first substrate.

6. The system of claim 1 wherein the second processor set is programmed and/or connected to avoid performing instructions received from the first processor set.

7. A method comprising:
providing a computer system comprising: a first processor set, a second processor set, a volatile memory hardware set, an intrusion detection hardware set, and an intrusion response hardware set;
running an operating system, by the first processor set, to control basic operations of the computer system;
storing data in the volatile memory hardware set for use by the first processor set;
sending out a set of first signal(s) including at least one signal by the intrusion detection hardware set;
receiving, by the second processor set, the set of first signal(s);
processing, by the second processor set, the set of first signal(s) to determine whether a physical access condition exists;
responsive to a determination that a physical access condition exists, sending out a set of response signal(s) including at least one signal by the second processor set;
receiving, by the intrusion response hardware set, the set of response signal(s); and
responsive to the set of response signal(s), making, by the intrusion response hardware set, at least one responsive action to protect the volatile memory hardware set from unauthorized access related to the determined physical access condition.

8. The method of claim 7 further comprising the step of:
during at least a portion of the sending-out-a-set-of-response-signal(s) step, powering the second processor set by a power storage device.

9. A memory board assembly for use in a computer having an intrusion detection hardware set and an intrusion response hardware set, the assembly comprising:
a processing hardware set;
a set of VM chip(s) including at least one VM chip;
a substrate; and
a power storage device;
wherein:
the substrate is a VM board;
the processing hardware set, the set of VM chip(s) and power storage device are mounted on the substrate;
the processing hardware set is structured, located, connected and/or programmed to: (i) receive a first signal from the intrusion detection hardware set, (ii) determine whether a physical access condition exists based on the received first signal, and (iii) control an intrusion response to help prevent unauthorized access to data stored in the set of VM chip(s) related to the determined physical access signal; and
the power storage device and the processing hardware set are operatively connected so that the power storage device will continue to power operations of the processing hardware set even when power to the computer is interrupted.

10. The assembly of claim 9 wherein the assembly is self-contained and stand-alone relative to devices which may utilize the memory board assembly.

11. The assembly of claim 9 further comprising:
a connection hardware set;
wherein:
the connection hardware set is structured, located and/or connected to form an operative connection with a mother board of a computer.

12. The assembly of claim 11 wherein the assembly is in the form of a peripheral component interface (PCI) board that can be connected to a PCI slot.

13. The assembly of claim 9 further comprising:
thermal insulation material;
wherein:
the temperature insulation material is located around at least a portion of an outer surface of the assembly; and
the temperature insulation material structured, located and/or connected to help protect the volatile memory from physical access based attack in the form of a cryogenic attack.
